(19) United States
(12) Patent Application Publication
(10) Pub. No.: US 2025/0031135 A1
(43) Pub. Date: Jan. 23, 2025

(54) Access Point Localization Using Extended Reality Devices

(71) Applicant: Cisco Technology, Inc., San Jose, CA (US)

(72) Inventors: Avinash Kalyanaraman, San Francisco, CA (US); Samer M. Salam, Beirut (LB); Sri Gundavelli, San Jose, CA (US)

(21) Appl. No.: 18/353,353

(22) Filed: Jul. 17, 2023

(51) Int. Cl. H04W 48/16; H04B 17/20; H04B 17/27; H04W 64/00

(52) U.S. Cl. CPC H04W 48/16; H04B 17/253; H04B 17/27; H04W 64/006

(57) ABSTRACT

A method for automatically detecting and identifying wireless access points (WAPs) utilizing a wireless electronic device associated with a user is presented. The method includes detecting, by one or more sensors of the wireless electronic device, a first object of a plurality of objects within an environment. The plurality of objects includes a plurality of wireless access points (WAPs). The method further includes determining a set of coordinate values associated with the first object based on an alignment of a coordinate system of the wireless electronic device and a predetermined coordinate system of the environment, estimating a depth value associated with the first object based at least in part on the set of coordinate values, and assigning a unique identifier to the first object based on the depth value and the set of coordinate values.

### TECHNICAL FIELD

This disclosure relates generally to access point localization, and, more specifically, to access point localization utilizing extended reality devices.

### BACKGROUND

Large indoor spaces, such as office spaces, living spaces, or other similar communal spaces with many users and heavy connectivity traffic may typically utilize wireless access points (WAPs) to support connectivity throughout the space. In some examples, upon installing the WAPs throughout the space, localization of users or other devices within the space may generally be computed relative to the known locations of each of the WAPs. Indeed, because localization of the users or other devices may be performed relative to each of the WAPs, it becomes useful to ensure that each of the WAPs are first themselves accurately localized. Otherwise, any error (e.g., drift) in localizing each of the WAPs may also manifest as an error (e.g., drift) in the localization of users or other devices within the space. It may be useful to provide techniques for accurately and efficiently localizing WAPs within large indoor spaces.

### BRIEF DESCRIPTION OF THE DRAWINGS

FIG. 1 illustrates an example extended reality (XR) system.

FIG. 2 illustrates an indoor environment into which a number of wireless access points (WAPs) may be detected and identified utilizing a wearable wireless electronic device.

FIG. 3 illustrates a flow diagram of a method for automatically detecting and identifying WAPs utilizing a wearable wireless electronic device of a user as the user traverses one or more indoor environments.

FIG. 4 illustrates an example computer system.

### DESCRIPTION OF EXAMPLE EMBODIMENTS

### Overview

The present embodiments are directed to techniques for automatically detecting and identifying wireless access points (WAPs) utilizing an extended reality (XR) device of a user as the user traverses one or more indoor environments into which the WAPs are deployed. In particular embodiments, a wireless electronic device associated with a user may detect, by one or more sensors of the wireless electronic device, a first object of a plurality of objects within an environment. In one embodiment, the plurality of objects may include a plurality of wireless access points (WAPs). In particular embodiments, the wireless electronic device may include an extended reality (XR) electronic device configured to be worn by the user within the environment. In particular embodiments, the one or more sensors may include one or more of an inertial measurement unit (IMU), a monochromatic camera, a visible-light camera, an infrared (IR) camera, a depth camera, a light-emitting diode (LED), an accelerometer, a magnetometer, a gyroscope, or a transceiver.

In particular embodiments, the wireless electronic device may then determine a set of coordinate values associated with the first object based on an alignment of a coordinate system of the wireless electronic device and a predetermined coordinate system of the environment. In particular embodiments, prior to determining the set of coordinate values associated with the first object, the wireless electronic device may then execute a calibration of the wireless electronic device with respect to the environment to align the coordinate system of the wireless electronic device to the predetermined coordinate system of the environment. For example, in one embodiment, the calibration of the wireless electronic device with respect to the environment may be executed utilizing a Kabsch algorithm. In particular embodiments, the wireless electronic device may then estimate a depth value associated with the first object based at least in part on the set of coordinate values. For example, in some embodiments, the wireless electronic device may estimate the depth value associated with the first object by estimating the depth value based on at least one of a depth image of the first object captured utilizing a depth camera of the wireless electronic device, an epipolar geometry calculation performed utilizing one or more stereo cameras of the wireless electronic device, an eye gaze of the user with respect to the first object, or an image recognition analysis of a captured image of the first object.

In particular embodiments, the wireless electronic device may then assign a unique identifier to the first object based at least in part on the depth value and the set of coordinate values. For example, in some embodiments, the wireless electronic device may assign the unique identifier to the first object by determining a media access control (MAC) address of the first object, and labeling the first object utilizing the MAC address, the depth value, and the set of coordinate values. In particular embodiments, the wireless electronic device may determine the MAC address of the first object by determining the MAC address of the first object based on at least one of a received signal strength indication (RSSI) associated with the first object, a light-emitting diode (LED) modulation indication received from the first object, or a geofencing boundary determined with respect to the first object.

In particular embodiments, the unique identifier may include a first unique identifier, and the wireless electronic device may detect, by the one or more sensors of the wireless electronic device, a second object of the plurality of objects within the environment, determine a second set of coordinate values associated with the second object based on the alignment of the coordinate system of the wireless electronic device and the predetermined coordinate system of the environment, determine a second depth value associated with the second object based at least in part on the second set of coordinate values, and assign a second unique identifier to the second object based on the second depth value and the second set of coordinate values. For example, in particular embodiments, the wireless electronic device may assign the second unique identifier to the second object by determining a second media access control (MAC) address of the second object, and labeling the second object utilizing the second MAC address, the second depth value, and the second set of coordinate values.

Technical advantages of particular embodiments of this disclosure may include one or more of the following. Certain systems and methods described herein may provide accurate and close-loop computation and mapping of location of devices and/or users by fitting a user with an XR device, which is calibrated to each space to overcome potential drift in the localization of a WAP within the space. For example, in accordance with the present embodiments, the user while wearing the XR device is directed to a known location to establish a frame of reference with respect to the XR device and the space, and then the XR device performs one or more mathematical axes rotations to realign the frame of reference. The XR device then calculates 3D coordinates (X, Y, Z coordinates) of the WAP and utilizes one or more RSSI signals associated with the WAP to accurately identify and label the WAP. To complete identifying and labeling the remaining WAPs within the space, the user while wearing the XR device simply navigates each subspace including a WAP and detects and captures the WAP.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

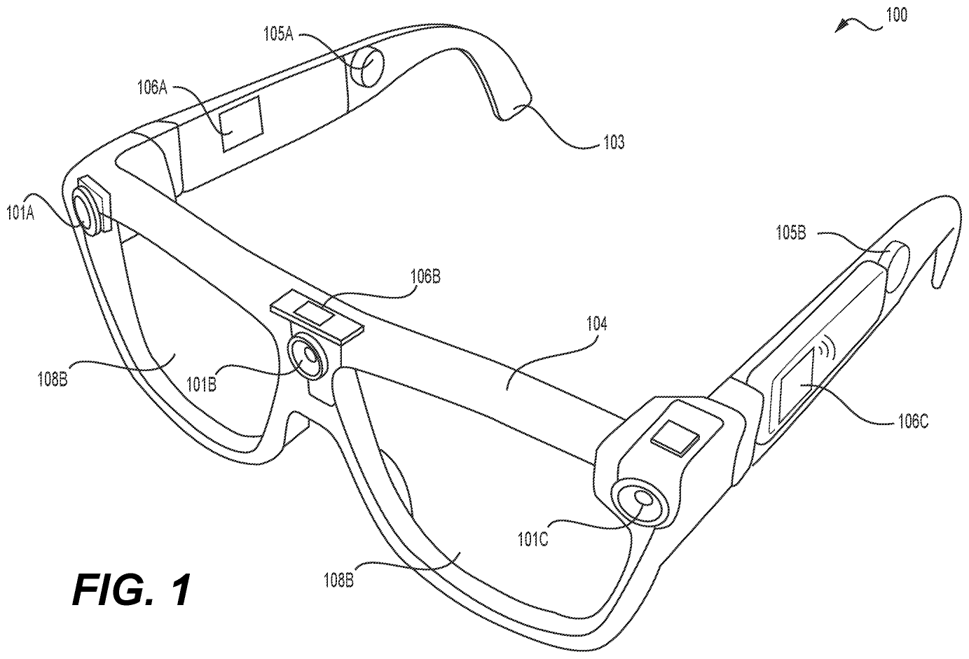

FIG. 1 illustrates an example extended reality system 100, in accordance with the presently disclosed embodiments. In particular embodiments, the extended reality system 100 may include a wearable wireless electronic device 103 including one or more sensors 101A, 101B, and 101C, a frame 104, one or more processors 106A, 106B, and 106C, one or more displays 108A and 108B, and/or or additional sensor components 105A and 105B. In particular embodiments, a user 102 may wear the wearable wireless electronic device 103. For example, in one embodiment, the wearable wireless electronic device 103 may display visual extended reality (XR) content (e.g., virtual reality (VR) content, augmented reality (AR) content, mixed-reality (MR) content, and so forth) to the user 102.

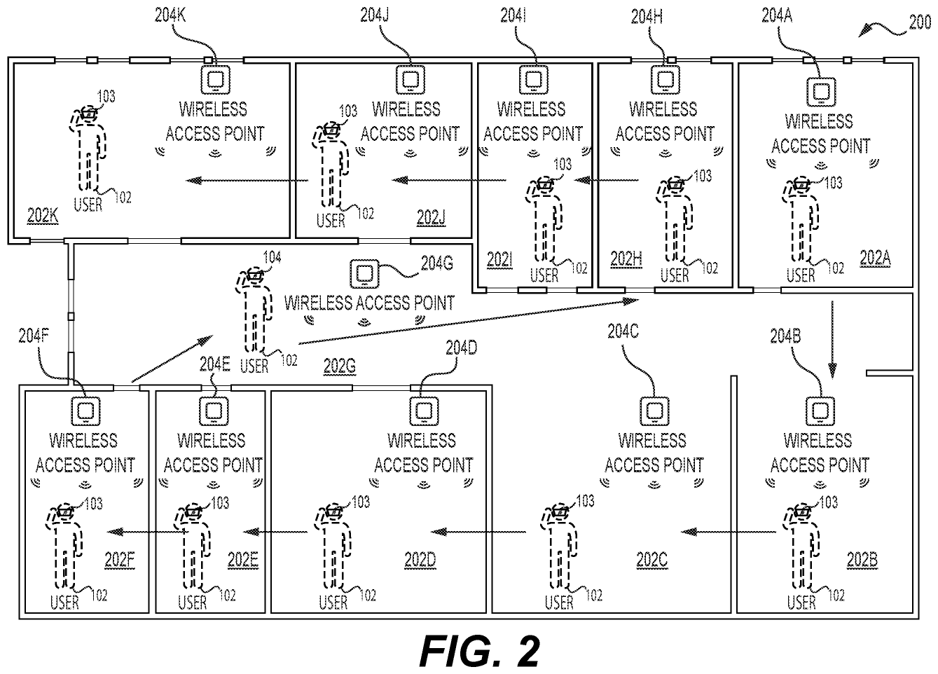

In particular embodiments, as will be further appreciated below with respect to FIG. 2, the wearable wireless electronic device 103 may be utilized for automatically detecting and identifying wireless access points (WAPs) as the user 102 traverses one or more indoor environments into which the WAPs are deployed. For example, in particular embodiments, the wearable wireless electronic device 103 may include a lightweight head-mounted display (HMD) (e.g., goggles, eyeglasses, spectacles, and so forth). In particular embodiments, the wearable wireless electronic device 103 may also include a non-HMD device, such as a lightweight, handheld device or one or more laser projecting spectacles (e.g., spectacles that may project a low-powered laser onto a user's retina to project and display image or depth content to the user 102).

In particular embodiments, the one or more sensors 101A, 101B, and 101C may include one or more cameras (e.g., one or more monochromatic cameras, one or more visible-light cameras, one or more infrared (IR) cameras, one or more depth cameras, and so forth) that may be suitable for capturing images and videos of indoor environments into which the WAPs are deployed. In particular embodiments, the one or more sensors 101A, 101B, and 101C may further include cameras that may be part of an eye tracking system directed toward one or more eyes of the user 102 and utilized to determine vergence distance and/or eye gaze of the user 102. In particular embodiments, the one or more processors 106A, 106B, and 106C may include one or more XR graphics processors, one or more artificial intelligence (AI) accelerators, and/or one or more wireless connectivity processors.

For example, in particular embodiments, one or more of the processors 106A, 106B, and 106C may be suitable for executing image data processing and video data processing of camera captures of WAPs and causing the one more displays 108A and 108B to display image and video content to the user 102 in accordance with the presently disclosed embodiments. In particular embodiments, one or more other processors of the processors 106A, 106B, and 106C may be suitable for executing image classification, text classification, object detection and classification, image segmentation, and/or other computationally intensive applications suitable for detecting and identifying WAPs in accordance with the presently disclosed embodiments.

In particular embodiments, one or more of the processors 106A, 106B, and 106C may be suitable for supporting connectivity and communication over any of various wireless communications networks (e.g., WLAN, WAN, PAN, cellular, WMN, WiMAX, GAN, 6LowPAN, and so forth) that may be suitable for communicatively coupling the wearable wireless electronic device 103 to one or more other wearable wireless electronic devices 103 and/or to a central computing platform (e.g., local computing platform or remote computing platform) for monitoring detected and identified WAPs in accordance with the present embodiments. In particular embodiments, the one more displays 108A and 108B may be transparent or translucent for allowing the user 102 to peer through the one more displays 108A and 108B to see, for example, the real world while also displaying XR content to the user 102.

In particular embodiments, the additional sensor components 105A and 105B may, in addition to cameras, include one or more of an inertial measurement unit (IMU), one or more light-emitting diodes (LEDs), one or more accelerometers, one or more magnetometers, one or more gyroscopes, or any of various other sensors that may be suitable for automatically detecting WAPs utilizing as the user 102 traverses one or more indoor environments into which the WAPs are deployed in accordance with the present embodiments. Although not illustrated, as previously noted, in particular embodiments, the wearable wireless electronic device 103 may be communicatively coupled to a central computing platform or one or more cloud-based servers to which the wearable wireless electronic device 103 may provide real-time or near real-time data, such as sensor data, communications data, location data, and so forth.

FIG. 2 illustrates an indoor environment 200 into which a number of WAPs may be detected and identified utilizing a wearable wireless electronic device, in accordance with the presently disclosed embodiments. In particular embodiments, the indoor environment 200 may include, for example, a large indoor space, such as an office space, a living space, or similar communal environment in which a number of users 102 may desire to connect to a wireless communications network (e.g., WLAN, WAN, WiMAX, and so forth). In particular embodiments, the indoor environment 200 may include a number of subspaces 202A, 202B, 202C, 202D, 202E, 202F, 202G, 202H, 202I, 202J, and 202K (e.g., individual rooms, offices, lobbies, and so forth) in which a number of WAPs 204A, 204B, 204C, 204D, 204E, 204F, 204G, 204H, 204I, 204J, and 204K may be installed. In particular embodiments, the number of WAPs 204A-204K may each include, for example, any wireless communications device that may be suitable for establishing a wireless communications network (e.g., WLAN, WAN, WiMAX, and so forth) within the one or more subspaces 202A-202K.

In particular embodiments, in accordance with the presently disclosed techniques, it may be useful to automatically detect, identify, and localize the number of WAPs 204A-204K utilizing the wearable wireless electronic device 103 (e.g., XR device) as the user 102 traverses within the one or more subspaces 202A-202K. In particular embodiments, once the user 102A enters into the subspace 202A, for example, the wearable wireless electronic device 103 as worn by the user 102 may detect the WAP 204A. For example, in particular embodiments, the user 102A may navigate to a position near, around, or beneath the WAP 204A and focus their head pose in order for the wearable wireless electronic device 103 to capture an image of the WAP 204A or detect a signal associated with the WAP 204A. In particular embodiments, as the user 102A navigates to each of the one or more subspaces 202A-202K, the wearable wireless electronic device 103 may also be utilized to perform wireless site-survey of each of the one or more subspaces 202A-202K within the indoor environment 200.

In particular embodiments, the wearable wireless electronic device 103 may then execute a calibration of the wearable wireless electronic device 103 with respect to the subspace 202A to align the coordinate system of the wearable wireless electronic device 103 to the predetermined coordinate system of the subspace 202A. For example, in one embodiment, the calibration of the wearable wireless electronic device 103 with respect to the subspace 202A may be executed utilizing a Kabsch algorithm. In particular embodiments, the wearable wireless electronic device 103 may then determine a set of coordinate values (e.g., X, Y coordinates) associated with the WAP 204A based on an alignment of a coordinate system of the wearable wireless electronic device 103 and a predetermined coordinate system of the subspace 202A. For example, in particular embodiments, the wearable wireless electronic device 103 may perform the calibration by guiding the user 102 to navigate to a known reference location within the subspace 202A (e.g., underneath the WAP 204A), and then utilizing the predetermined location to perform the alignment of a coordinate system of the wearable wireless electronic device 103 and the predetermined coordinate system of the subspace 202A.

As an example, for a calibration point P that has measured coordinates (1, −6), based on the predetermined room coordinate of P, the wearable wireless electronic device 103 may determine its calibration point P coordinate to be (0, 6.08). Then, taking these as complex numbers, the wearable wireless electronic device 103 may then generate an angle of (0, 6.08) as π/2 and an angle of (1, −6) as arctan (−6). Next, multiplying by rotation matrix R=[cos (a)−sin (a); sin (a) cos (a)], where α=π/2−arctan (−6), the wearable wireless electronic device 103 may then generate the correct coordinate axis alignment. The wearable wireless electronic device 103 may then multiply all computed coordinate values (X, Y coordinates) by R to align the coordinate system of the wearable wireless electronic device 103 to the predetermined coordinate system of the subspace 202A.

In particular embodiments, the wearable wireless electronic device 103 may then estimate a depth value (Z coordinate) associated with the WAP 204A based on the set of coordinate values (X, Y coordinates). For example, in particular embodiments, the wearable wireless electronic device 103 may estimate the depth value (Z coordinate) associated with the WAP 204A by estimating the depth value (Z coordinate) based on one of a depth image of the WAP 204A captured utilizing a depth camera of the wearable wireless electronic device 103, an epipolar geometry calculation performed utilizing one or more stereo cameras of the wearable wireless electronic device 103, an eye gaze of the user 102 with respect to the WAP 204A, or an image recognition analysis (e.g., image classification, object detection and classification, semantic segmentation, and so forth) of an image of the WAP 204A captured by the wearable wireless electronic device 103. In particular embodiments, the wearable wireless electronic device 103 may estimate the depth value (Z coordinate) as the height of the WAP 204A measured from the floor of the subspace 202A (e.g., the Z-dimension and/or elevation).

In particular embodiments, the wearable wireless electronic device 103 may then assign a unique identifier to the WAP 204A based at least in part on the computed depth value (Z coordinate) and the set of coordinate values (X, Y coordinates). For example, in particular embodiments, the wearable wireless electronic device 103 may assign the unique identifier to the WAP 204A by determining a media access control (MAC) address of the WAP 204A, and further labeling the WAP 204A utilizing the MAC address, the depth value (Z coordinate), and the set of coordinate values (X, Y coordinates). For example, in particular embodiments, the wearable wireless electronic device 103 may determine the MAC address of the WAP 204A by determining the MAC address of the WAP 204A based on one of a received RSSI associated with the WAP 204A, an LED modulation indication received from the WAP 204A, or a geofencing boundary determined with respect to the WAP 204A. Specifically, in accordance with the present embodiments, the assigned unique identifier signifies that the WAP 204A with that particular assigned unique identifier is at the precise location (XYZ 3D position). For example, in some embodiments, the unique identifier may be determined utilizing the MAC address of the WAP 204A determined by the RSSI, and then the central computing platform may then utilize a look up table (LUT) to determine additional device information of the WAP 204A (e.g., manufacturer, model, antenna type, and so forth).

In particular embodiments upon assigning the unique identifier to the WAP 204A and labeling the WAP 204A utilizing the MAC address, the depth value (Z coordinate), and the set of coordinate values (X, Y coordinates), the user 102 while wearing the wearable wireless electronic device 103 may then be directed to proceed to a next WAP 204B within a next subspace 202B and so on, for example, until each of the number of WAPs 204A-204K in the indoor environment 200 are identified and labeled. In particular embodiments, once having received the depth value (Z coordinate), the set of coordinate values (X, Y coordinates), and the received RSSI associated with each of the number of WAPs 204A-204K (e.g., the 3D positions and the observed wireless coverage), it may be further useful for the central computing platform to generate a recommendation for an optimal location or placement for each of the number of WAPs 204A-204K with respect to the respective subspaces 202A-202K based on the current positions and observed wireless coverage of each of the number of WAPs 204A-204K.

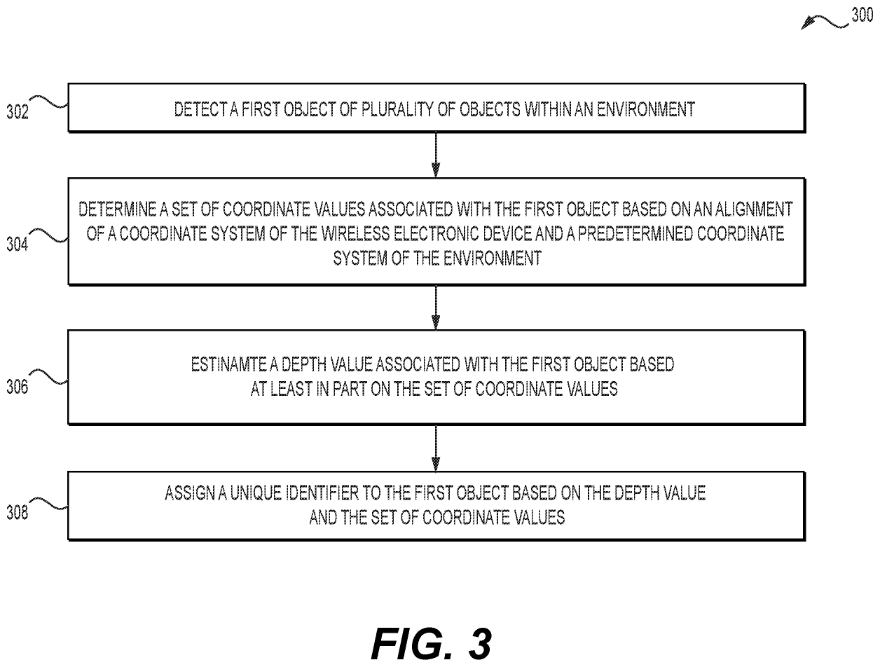

FIG. 3 illustrates a flow diagram of a method 300 for automatically detecting and identifying wireless access points (WAPs) utilizing a wearable wireless electronic device (extended reality (XR) device) of a user as the user traverses one or more indoor environments into which the WAPs are deployed, in accordance with the presently disclosed embodiments. The method 300 may be performed utilizing one or more processors that may include hardware (e.g., a general purpose processor, a graphic processing units (GPU), an application-specific integrated circuit (ASIC), a system-on-chip (SoC), a microcontroller, a field-programmable gate array (FPGA), or any other processing device(s) that may be suitable for processing image data), software (e.g., instructions running/executing on one or more processors), firmware (e.g., microcode), or any combination thereof.

The method 300 may begin at block 302 with the wearable wireless electronic device 103 detecting, by one or more sensors of the wireless electronic device, a first object of a plurality of objects within an environment. In some examples, the number of objects may include a number of wireless access points (WAPs). In particular embodiments, the one or more sensors may include one or more of an IMU, a monochromatic camera, a visible-light camera, an IR camera, a depth camera, an LED, an accelerometer, a magnetometer, a gyroscope, a transceiver, or any of various other sensors that may be suitable for detecting, capturing, or perceiving WAPs within an indoor environment.

The method 300 may continue at block 304 with the wearable wireless electronic device 103 determining a set of coordinate values associated with the first object based on an alignment of a coordinate system of the wireless electronic device and a predetermined coordinate system of the environment. For example, in some embodiments, determining the set of coordinate values associated with the first object may first include executing a calibration (e.g., utilizing a Kabsch algorithm) of the wearable wireless electronic device 103 with respect to the environment to align the coordinate system of the wearable wireless electronic device 103 to the predetermined coordinate system of the environment.

The method 300 may continue at block 306 with the wearable wireless electronic device 103 estimating a depth value associated with the first object based at least in part on the set of coordinate values. For example, in some embodiments, the wireless wearable electronic device 103 may estimate the depth value associated with the first object by estimating the depth value based on at least one of a depth image of the first object captured utilizing a depth camera of the wearable wireless electronic device 103, an epipolar geometry calculation performed utilizing one or more stereo cameras of the wearable wireless electronic device 103, an eye gaze of the user with respect to the first object, or an image recognition analysis of a captured image of the first object.

The method 300 may then conclude at block 308 with the wearable wireless electronic device 103 assigning a unique identifier to the first object based on the depth value and the set of coordinate values. For example, in some embodiments, the wearable wireless electronic device 103 may assign the unique identifier to the first object by determining a MAC address of the first object, and labeling the first object utilizing the MAC address, the depth value, and the set of coordinate values. In particular embodiments, the wearable wireless electronic device 103 may determine the MAC address of the first object by determining the MAC address of the first object based on at least one of a received RSSI associated with the first object, an LED modulation indication received from the first object, or a geofencing boundary determined with respect to the first object.

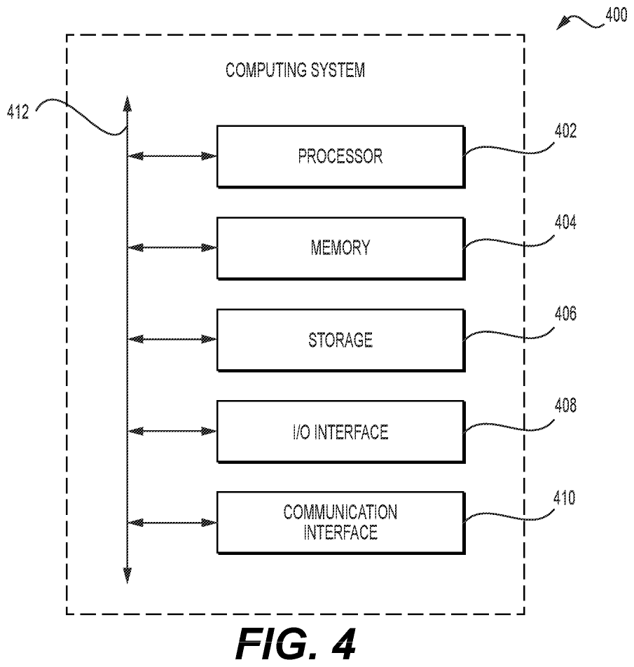

FIG. 4 illustrates an example computer system 400 that may be useful in performing one or more of the foregoing techniques as presently disclosed herein. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein.

As an example, and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate. In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example, and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example, and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402.

Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 602. Although this disclosure describes and illustrates a particular processor, this disclosure contemplates any suitable processor.

In particular embodiments, memory 404 includes main memory for storing instructions for processor 402 to execute or data for processor 402 to operate on. As an example, and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere).

One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example, and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example, and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it.

As an example, and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, by a wireless electronic device associated with a user, comprising:
detecting, by one or more sensors of the wireless electronic device, a first object of a plurality of objects within an environment, wherein the plurality of objects comprises a plurality of wireless access points (WAPs);
determining a set of coordinate values associated with the first object based on an alignment of a coordinate system of the wireless electronic device and a predetermined coordinate system of the environment;
estimating a depth value associated with the first object based at least in part on the set of coordinate values; and
assigning a unique identifier to the first object based at least in part on the depth value and the set of coordinate values.

2. The method of claim 1, wherein the one or more sensors comprises one or more of an inertial measurement unit (IMU), a monochromatic camera, a visible-light camera, an infrared (IR) camera, a depth camera, a light-emitting diode (LED), an accelerometer, a magnetometer, a gyroscope, or a transceiver.

3. The method of claim 1, further comprising:
prior to determining the set of coordinate values associated with the first object:
executing a calibration of the wireless electronic device with respect to the environment to align the coordinate system of the wireless electronic device to the predetermined coordinate system of the environment.

4. The method of claim 3, wherein the calibration of the wireless electronic device with respect to the environment is executed utilizing a Kabsch algorithm.

5. The method of claim 1, wherein assigning the unique identifier to the first object further comprises:
determining a media access control (MAC) address of the first object; and
labeling the first object utilizing the MAC address, the depth value, and the set of coordinate values.

6. The method of claim 5, wherein determining the MAC address of the first object comprises determining the MAC address of the first object based on at least one of:
a received signal strength indication (RSSI) associated with the first object;
a light-emitting diode (LED) modulation indication received from the first object; or
a geofencing boundary determined with respect to the first object.

7. The method of claim 1, wherein the unique identifier comprises a first unique identifier, the method further comprising:
detecting, by the one or more sensors of the wireless electronic device, a second object of the plurality of objects within the environment;
determining a second set of coordinate values associated with the second object based on the alignment of the coordinate system of the wireless electronic device and the predetermined coordinate system of the environment;
determining a second depth value associated with the second object based at least in part on the second set of coordinate values; and
assigning a second unique identifier to the second object based on the second depth value and the second set of coordinate values.

8. The method of claim 7, wherein assigning the second unique identifier to the second object further comprises:
determining a second media access control (MAC) address of the second object; and
labeling the second object utilizing the second MAC address, the second depth value, and the second set of coordinate values.

9. The method of claim 1, wherein estimating the depth value associated with the first object comprises estimating the depth value based on at least one of:
a depth image of the first object captured utilizing a depth camera of the wireless electronic device;
an epipolar geometry calculation performed utilizing one or more stereo cameras of the wireless electronic device;
an eye gaze of the user with respect to the first object; or
an image recognition analysis of a captured image of the first object.

10. The method of claim 1, wherein the wireless electronic device comprises an extended reality (XR) electronic device configured to be worn by the user within the environment.

11. A wireless electronic device, comprising:
one or more sensors;
one or more non-transitory computer-readable storage media including instructions; and
one or more processors coupled to the one or more sensors and the storage media, the one or more processors configured to execute the instructions to:
detect, by the one or more sensors, a first object of a plurality of objects within an environment, wherein the plurality of objects comprises a plurality of wireless access points (WAPs);
determine a set of coordinate values associated with the first object based on an alignment of a coordinate system of the wireless electronic device and a predetermined coordinate system of the environment;
estimate a depth value associated with the first object based at least in part on the set of coordinate values; and
assign a unique identifier to the first object based at least in part on the depth value and the set of coordinate values.

12. The wireless electronic device of claim 11, wherein the one or more sensors comprises one or more of an inertial measurement unit (IMU), a monochromatic camera, a visible-light camera, an infrared (IR) camera, a depth camera, a light-emitting diode (LED), an accelerometer, a magnetometer, a gyroscope, or a transceiver.

13. The wireless electronic device of claim 11, wherein the instructions further comprise instructions to:
prior to determining the set of coordinate values associated with the first object:
execute a calibration of the wireless electronic device with respect to the environment to align the coordinate system of the wireless electronic device to the predetermined coordinate system of the environment.

14. The wireless electronic device of claim 13, wherein the calibration of the wireless electronic device with respect to the environment is executed utilizing a Kabsch algorithm.

15. The wireless electronic device of claim 11, wherein the instructions to assign the unique identifier to the first object further comprise instructions to:
determine a media access control (MAC) address of the first object; and
label the first object utilizing the MAC address, the depth value, and the set of coordinate values.

16. The wireless electronic device of claim 15, wherein the instructions to determine the MAC address of the first object further comprise instructions to determine the MAC address of the first object based on at least one of:
a received signal strength indication (RSSI) associated with the first object;
a light-emitting diode (LED) modulation indication received from the first object; or
a geofencing boundary determined with respect to the first object.

17. The wireless electronic device of claim 11, wherein the unique identifier comprises a first unique identifier, the instructions further comprising instructions to:
detect, by the one or more sensors, a second object of the plurality of objects within the environment;
determine a set of coordinate values associated with the second object based on the alignment of the coordinate system of the wireless electronic device and the predetermined coordinate system of the environment;
determine a second depth value associated with the second object based at least in part on the second set of coordinate values; and
assign a second unique identifier to the second object based on the second depth value and the second set of coordinate values.

18. The wireless electronic device of claim 17, wherein the instructions to assign the second unique identifier to the second object further comprise instructions to:
determine a second media access control (MAC) address of the second object; and
label the second object utilizing the second MAC address, the second depth value, and the second set of coordinate values.

19. The wireless electronic device of claim 11, wherein the instructions to estimate the depth value associated with the first object further comprise instructions to estimate the depth value based on at least one of:
a depth image of the first object captured utilizing a depth camera of the wireless electronic device;
an epipolar geometry calculation performed utilizing one or more stereo cameras of the wireless electronic device;
an eye gaze of the user with respect to the first object; or
an image recognition analysis of a captured image of the first object.

20. A non-transitory computer-readable medium comprising instructions that, when executed by one or more processors of a wireless electronic device, cause the one or more processors to:
detect, by one or more sensors of the wireless electronic device, a first object of a plurality of objects within an environment, wherein the plurality of objects comprises a plurality of wireless access points (WAPs);
determine a set of coordinate values associated with the first object based on an alignment of a coordinate system of the wireless electronic device and a predetermined coordinate system of the environment;
estimate a depth value associated with the first object based at least in part on the set of coordinate values; and
assign a unique identifier to the first object based at least in part on the depth value and the set of coordinate values.
